(19) United States
(12) Patent Application Publication
(10) Pub. No.: US 2018/0149367 A1
(43) Pub. Date: May 31, 2018

(54) MOVABLE COOKING BARRIER SYSTEM

(71) Applicants: Rene' Faulstich, Herborn (DE); Richard A. Conlin, Novi, MI (US)

(72) Inventors: Rene' Faulstich, Herborn (DE); Richard A. Conlin, Novi, MI (US)

(21) Appl. No.: 15/365,311

(22) Filed: Nov. 30, 2016

(51) Int. Cl. F24C 15/12; A47J 36/00

(52) U.S. Cl. CPC F24C 15/12; A47J 36/00

(57) ABSTRACT

A cooking barrier that is movable to minimize harm caused by splashes of food during the cooking and frying process. The cooking barrier includes a mesh or screen material movable between a storage condition and an operable condition preventing splattering food particles from penetrating the cooking barrier. The cooking barrier may include a plurality of mesh or screen materials oriented in vertical, horizontal and there between so as to define a cooking area for preventing the splattering food particles from escaping from.

### BACKGROUND OF THE INVENTION

The present invention relates to cooking accessories and, more particularly, to a cooking barrier that is movable to minimize harm caused by splashes of food during the cooking and/or frying process.

Cooking and frying produces vapor and air borne splashes of foods. Venting of oily vapors may be effective for reducing damages to surfaces due to the vapor, but does not protect people, pets and surfaces from the hot and staining splashes from the cooking and frying process, where burns and damage to clothing or surfaces are not unusual.

As can be seen, there is a need for a cooking barrier that is movable to minimize harm caused by splashes of food during the cooking and frying process, minimizing damage to nearby surfaces and reduces the danger to people, pets, and property.

### SUMMARY OF THE INVENTION

In one aspect of the present invention, a system for preventing splattering particles from escaping a controlled area includes a controlled area; at least one mesh or screen material; and a position device interconnecting each mesh or screen material to the controlled area so that each mesh or screen material is movable between a storage condition and an operable condition preventing particles from escaping a portion of the controlled area.

In another aspect of the present invention, the system for preventing splattering particles from escaping a controlled area includes a controlled area defined in part by a surface area of a cooking apparatus; at least one mesh or screen material, wherein the at least one mesh or screen material comprises: a first mesh or screen material oriented in a horizontal orientation above the controlled area; and a second mesh or screen material oriented in a vertical orientation adjacent to a periphery of the controlled area; and a position device interconnecting each mesh or screen material to the controlled area so that each mesh or screen material is movable between a storage condition and an operable condition preventing particles from escaping a portion of the controlled area, wherein each position device comprises a pivotal connection.

In yet another aspect of the present invention, the above system further includes a frame for each mesh or screen material, wherein each frame defines a shape, wherein each respective mesh or screen material spans across said shape, and wherein each frame includes a female and male member that are removably joinable so as to sandwich a periphery of each respective mesh or screen material.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a side elevation view of an exemplary embodiment of the present invention, shown in use;

FIG. 3 is an exploded view of an exemplary embodiment of the present invention; and

FIG. 4 is a side elevation view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cooking barrier that is movable to minimize harm caused by splashes of food during the cooking and frying process.

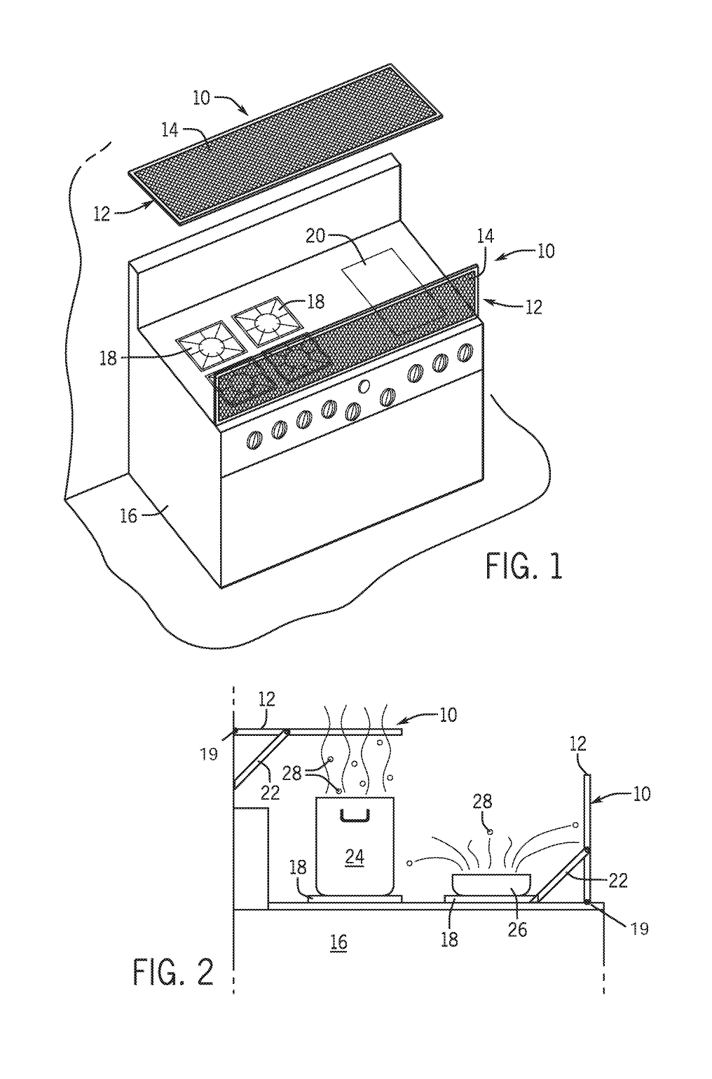

Referring to FIGS. 1 through 4, the present invention may include a moveable stovetop barrier 10 having at least one frame 12 for supporting a mesh or screen material 14. Each frame 12 may be made of material that can be repeatedly bent without fracturing, such as polyethylene, polypropylene, vinyl, nylon, various impregnated or laminated fibrous materials, various plasticized materials, various metallic materials and the like. Each frame 12 may define a periphery of a substantially rectangular, oval, square, triangular or other geometric shape so long as each frame 12 functions in accordance with the present invention as described herein. The mesh or screen material 14 may attach to each frame 12 so that the former extends through the shape defined by each of the latter, as illustrated in the Figures.

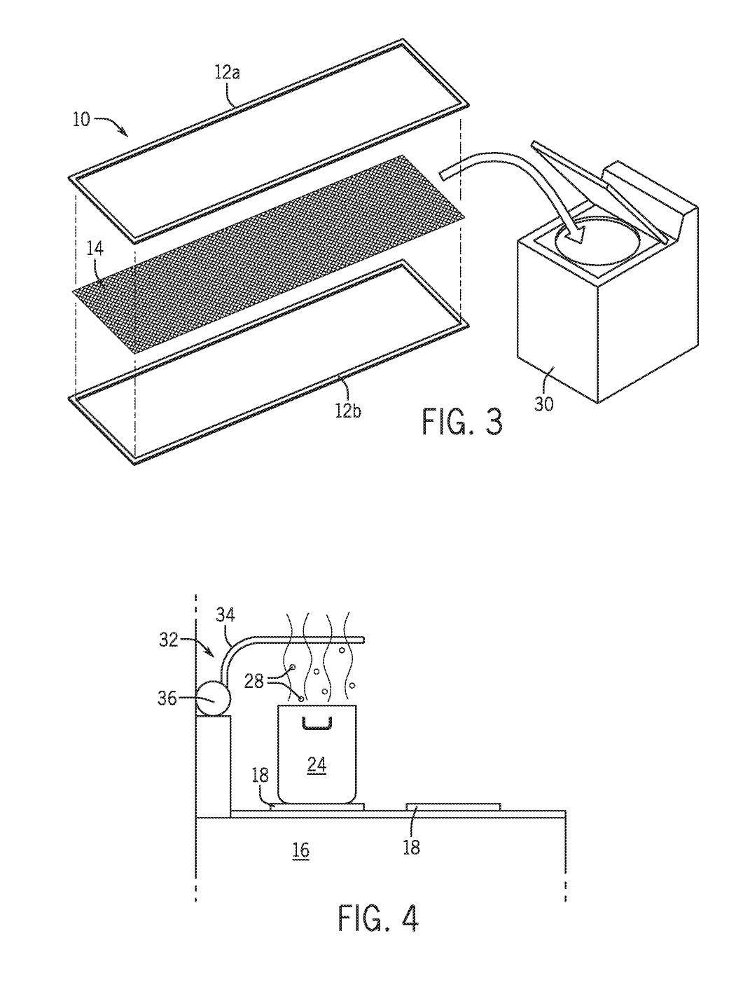

In certain embodiments, each frame 12 may include a female member 12a and a male member 12b that are dimensioned to be coextensive so as to be joined, thereby sandwiching a periphery of the mesh or screen material 14 there between, as illustrated in FIG. 3. In this manner, the mesh or screen material 14 is removable from each frame 12 so that it can be readily cleaned, for example by rolling up and placing in a washing machine 30. The female and male members 12a and 12b may be spring loaded.

Each frame 12 may be disposed along or adjacent to a surface of a cooking apparatus, such as the stovetop of a stove 16, typically adjacent to a burner or other heating element 18 thereof, where cooking containers, such as deep fat fryers 20, pots 24, pans 26, and the like, may be emitting hot food particles 28 during a cooking or frying process, as illustrated in FIGS. 2 and 4. Each frame 12 may be disposed in either a vertical or horizontal orientation relative to the heating element 18. In certain embodiments, the horizontal orientation may be above the heating element 18, as illustrated in FIG. 4, providing an upper limit to a cooking area or controlled area or a portion thereof, so that heated food particles 28 are prevented from travelling upwardly beyond that portion of cooking area. The vertical orientation may be disposed spaced between an adjacent heating element 18 and along a periphery of the stove 16 so as to serves as a protective fence along an edge of said cooking area, again keeping the food particles 28 within the cooking area and the cook and bystanders safe from said food particles 28. It being understood that the cooking area may be generally defined by the periphery of the stovetop and a predetermined distance there above. The predetermined distance may be in part defined by a height of cooking container and a working distance there above, wherein the working distance enables a cook to access manually operate needed utensils above the top of the cooking container.

The present invention may provide positioning device 22 enabling each frame 12 to be movable between a storage condition and an operative condition defining a fence or limits to at least a portion of the edge or limits of the cooking area. The storage condition may be folded away from the cooking area so as to not present an obstacle between a cook and the cooking area. The positioning device 22 may include flex arms, straps, clips, snaps or the like, and a pivotal connection 19 interconnecting the respective frame 12 to the stove 16 or an adjacent supporting structure.

In some embodiments, the present invention may include just a malleable mesh or screen material or flex screen 34 that is retractable from the operative condition to the storage condition, wherein the storage condition is rolled up into a retractor 36. The flex screen 34 may be folded between a planar configuration and a folded configuration 32 so that the flex screen 34 is at least partially oriented in the horizontal or vertical orientation, as illustrated in FIG. 4.

A method of using the present invention may include the following. Providing the moveable stovetop barrier 10 disclosed above. A user may orient at least one frame 12 and/or mesh or screen material 14 in either a vertical or horizontal orientation so as to define a portion of a cooking area preventing splattering food particles 28 from escaping therefrom. Furthermore, the mesh or screen material 14 can be used as a canopy over foods or a guard over stove controls or around hot surfaces; in other words, the cooking area can be defined and redefined by positioning and reposition the at least one mesh or screen material 14 as needed. In certain embodiments, the present invention may be fitted to a cooking area such as a gas range or fry well, wherein the mesh or screen material 14 serves as a protector of people and surrounding surfaces, keeping splashes within the predetermine or defined cooking area and potentially hands and faces away from hot splash and burn danger. The mesh or screen material 14 is retractable or can be removed when not in use to a storage condition. In other embodiments, the mesh or screen material 14 and its respective frame 12 may be used in multiple ways to prevent damage to surfaces or prevent injury, and be operable “on demand,” remotely, electronically and the like.

This mesh can be an aftermarket product added or integral to the construction of the cook top, range, or stove, or fry well. Likewise, the present invention can also be used wherever there is a flying debris hazard or system controls that require access protection. For example, child safety or damage prevention over electronic devices.

It should be understood, of course, that the foregoing relates to exemplary embodiments of the invention and that modifications may be made without departing from the spirit and scope of the invention as set forth in the following claims.

What is claimed is:

1. A system for preventing splattering particles from escaping a controlled area, comprising:
a controlled area;
at least one mesh or screen material; and
a position device interconnecting each mesh or screen material to the controlled area so that each mesh or screen material is movable between a storage condition and an operable condition preventing particles from escaping a portion of the controlled area.

2. The system of claim 1, further comprising a frame for each mesh or screen material, wherein each frame defines a shape, and wherein each respective mesh or screen material spans across said shape.

3. The system of claim 2, wherein each frame includes a female and male member that are removably joinable so as to sandwich a periphery of each respective mesh or screen material.

4. The system of claim 1, wherein each position device comprises a pivotal connection.

5. The system of claim 1, wherein the controlled area is defined in part by a surface area of a cooking apparatus.

6. The system of claim 1, wherein the at least one mesh or screen material comprises:
a first mesh or screen material oriented in a horizontal orientation above the controlled area; and
a second mesh or screen material oriented in a vertical orientation adjacent to a periphery of the controlled area.

7. The system of claim 1, wherein each mesh or screen material is a malleable flex screen so as to be folded between a planar condition and a folded condition occupying the operative condition.

8. The system of claim 7, further comprising a retractor associated with each mesh or screen material, wherein each retractor is adapted to house its respective mesh or screen material in the storage condition.

9. A system for preventing splattering particles from escaping a controlled area, comprising:
a controlled area defined in part by a surface area of a cooking apparatus;
at least one mesh or screen material, wherein the at least one mesh or screen material comprises:
a first mesh or screen material oriented in a horizontal orientation above the controlled area; and
a second mesh or screen material oriented in a vertical orientation adjacent to a periphery of the controlled area; and
a position device interconnecting each mesh or screen material to the controlled area so that each mesh or screen material is movable between a storage condition and an operable condition preventing particles from escaping a portion of the controlled area, wherein each position device comprises a pivotal connection.

10. The system of claim 9, further comprising a frame for each mesh or screen material, wherein each frame defines a shape, and wherein each respective mesh or screen material spans across said shape.

11. The system of claim 10, wherein each frame includes a female and male member that are removably joinable so as to sandwich a periphery of each respective mesh or screen material.
